(19) United States
(12) Patent Application Publication
(10) Pub. No.: US 2024/0095757 A1
(43) Pub. Date: Mar. 21, 2024

(54) SYSTEMS AND METHODS FOR COMPLIANCE, KEYWORD FINDER, AND TRAINING TOOL

(71) Applicant: Regulatory Education Events, LLC dba Supplement Advisory Group, Longmont, CO (US)

(72) Inventor: Asa Waldstein, Longmont, CO (US)

(21) Appl. No.: 18/468,088

(22) Filed: Sep. 15, 2023

Related U.S. Application Data
(63) Continuation of application No. PCT/US2023/023354, filed on May 24, 2023.
(60) Provisional application No. 63/376,011, filed on Sep. 16, 2022.

(51) Int. Cl. G06Q 30/018

(52) U.S. Cl. CPC G06Q 30/018

(57) ABSTRACT

The provided herein are systems and methods for compliance, keyword finder, and training tool for avoiding risk.

### CROSS-REFERENCE TO RELATED APPLICATIONS

The present application claims priority to PCT application serial no. PCT/US2023/023354, filed May 24, 2023 and U.S. provisional application No. 63/376,011 filed Sep. 16, 2022, herein incorporated by reference in their entireties.

### BACKGROUND

The invention generally relates to software and more specifically to software for ensuring compliance of websites, marketing materials, and the like.

Finding risky words on the web and marketing material can help to mitigate the risk of FDA/FTC warning letters and lawsuits. Warning letters reference risky words on several-year-old company online material, which the company likely doesn't know are present.

The present application attempts to solve these problems as well as others.

### SUMMARY OF THE INVENTION

Provided herein are systems and methods for compliance, keyword finder, and training tool for avoiding risk.

The methods and systems are set forth in part in the description which follows, and in part will be obvious from the description, or can be learned by practice of the methods, apparatuses, and systems. The advantages of the methods and systems will be realized and attained by means of the elements and combinations particularly pointed out in the appended claims. It is to be understood that both the foregoing general description and the following detailed description are exemplary and explanatory only and are not restrictive of the methods and systems, as claimed.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

### BRIEF DESCRIPTION OF THE DRAWINGS

In the accompanying figures, like elements are identified by like reference numerals among the several preferred embodiments of the present invention.

FIG. 1 is a webpage showing the compliance system and method allowing a user to enter in a website URL and select from a predetermined list of keywords, according to one embodiment.

FIG. 2 is a webpage showing the keyword occurrence for the compliance system and method, according to one embodiment.

FIG. 3 is a webpage showing the compliance report reporting the keyword, risk level, possible suggestions, resources, and listing the content, according to one embodiment.

FIG. 4 is a FDA warning letter showing risky keywords.

FIG. 5 is a compliance report for bronchitis and the suggestions for the Entia Biosciences webpage.

FIG. 6 is a compliance report for anxiety and the suggestions for the FDC Nutrition webpage.

FIG. 7 is a compliance report for tumor and the suggestions for the Holographic Health webpage.

FIG. 8 is a compliance report for diabetes and the suggestions for the Holistic Healer & Wellness Center webpage.

FIG. 9 is a compliance report for tumor and the suggestions for the Nuturna International webpage.

FIG. 10A shows the compliance system and method for assessing social media compliance by scanning social media platforms; FIG. 10B shows the compliance system and method generating a video transcript and highlights the keywords flagged; and FIG. 10C shows the compliance system and method generating a report showing the keyword risk rating and showing the pages scanned.

FIG. 11 shows the compliance system and method comprises a document scan review 400, which finds risky phrases and suggest alternatives.

FIG. 12 shows the compliance system and method by scanning for risky phrases in banking and credit card reviews.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### DESCRIPTION OF EMBODIMENTS

Finding risky words on the web and marketing material can help to mitigate the risk of FDA/FTC warning letters and lawsuits. Warning letters from the FDA may reference risky words on company online material that may be several years old, which the company likely doesn't know are present. The compliance system and method helps companies learn about compliance and is an educational tool that teaches about risk, while risky words are identified and replaced. This compliance system and method finds and mitigates risk and teaches about compliance, an essential skill for any employee and company. The compliance system and method comprises a predetermined keyword risk rating level and providing alternative suggestions to replace highest risk, high risk, medium risk, low risk, or lowest risk keywords. This compliance system and method is run before publishing or posting content on the web. The compliance system and method reduce the amount of time regulatory teams spend reviewing marketing materials.

In one embodiment, the compliance system and method find keywords online and in documents. The compliance system and method comprises ranking keywords by risk level, and providing lower-risk alternatives and educational resource links. In one embodiment, the risk level is designated as highest risk, high risk, medium risk, low risk, or lowest risk. The compliance system and method finds predetermined words which are considered a regulatory risk, suggest lower risk alternatives, and educates the client for future development of webpages to avoid risk. In one embodiment, this compliance system and method help copywriters and marketers find and replace risky words before publishing articles, social media posts, or blogs. while teaching them about compliance. This compliance system and method is helpful for finding and replacing risky words on the current website and marketing copy, which may be hard to find or forgotten on the company website and marketing material. This compliance system and method is useful for finding risky words that are often flagged by credit card processors or banking institutions, in other embodiments.

This compliance system and method finds predetermined keywords. Each keyword has a risk level of lowest/low, medium, medium/high, high/highest, which is determined by the inventor. Each risk level has a meaning. For example, medium risk means the keyword may attract scrutiny, such as a lawsuit or warning letter, and changing it is suggested. A high-risk or highest risk level means there is a strong likelihood of legal action or a lawsuit. The risk level of certain keywords may change based on enforcement trends, litigation trends, or guidance from the government. Many keywords have lower-risk alternative verbiage suggestions which are determined by enforcement trends, litigation trends, or guidance from the government. Many keywords provide resource links to pertinent blogs, articles, videos, and other educational material. This invention can be used as a program, a software app, a web application, or web browser extension.

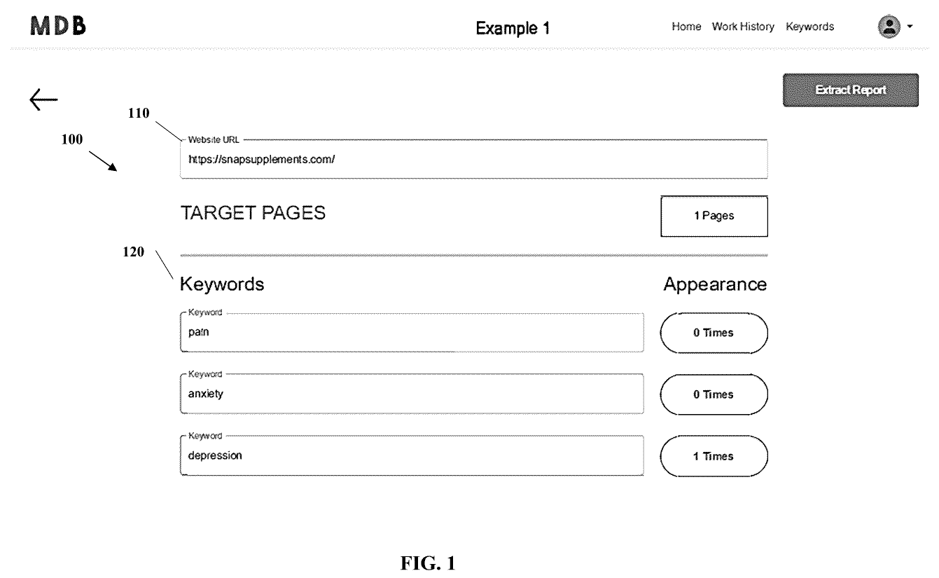

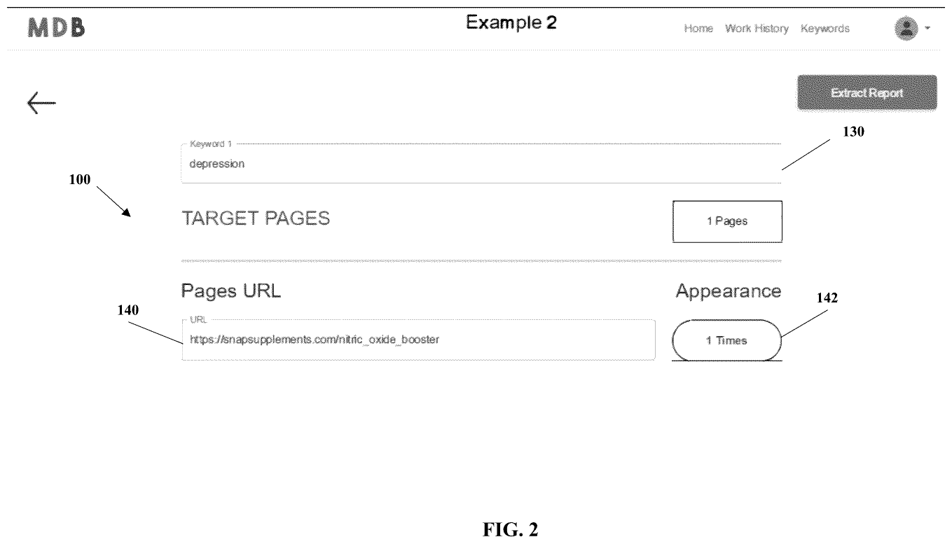

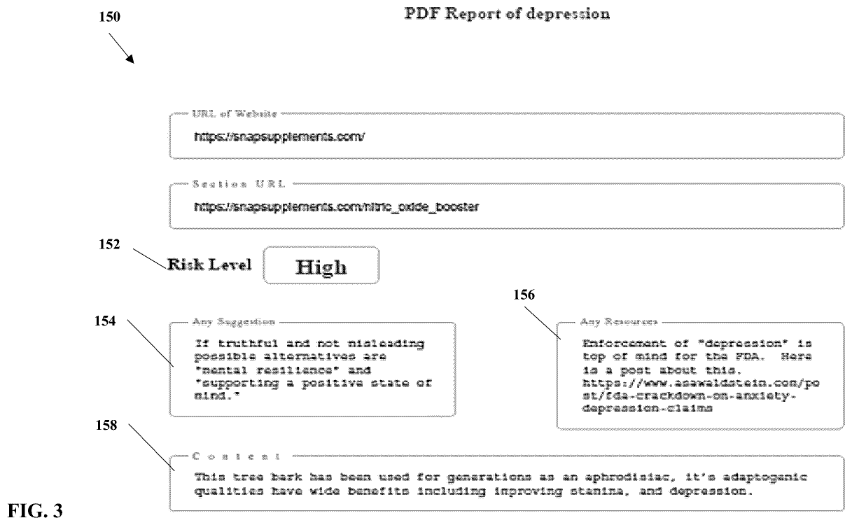

In one embodiment, the compliance system and method 100 is deployed for web search, the user enters in a web site URL 110 and selects from a predetermined list of keywords 120, as shown in FIG. 1. The keyword occurrence 130 is shown in FIG. 2. Clicking the link 140 will open all keyword occurrences and clicking the keyword 142 opens the URL for each keyword occurrence, which leads to a preloaded page with a compliance report 150 reporting the keyword, risk level 152, possible suggestions 154, resources 156, and listing the content 158, as shown in FIG. 3. Compliance reports can also be provided or exported for all keywords in spreadsheet format.

For document search, files can be uploaded into the compliance system and method, or a browser extension can be used. All predetermined keywords are searched, and when the user clicks on the keyword, a section of the screen opens with the risk level, possible alternative suggestions, and resources.

In one embodiment, the financial underwriters use the compliance system and method for financial or accounting compliance. In other embodiment, the compliance system and method comprises a live training and content development tool. Companies can check to see if proposed words are risky and search for possible alternative suggestions before writing content or making video content.

The compliance system and method may review documents, which may include a newspaper article, a social media post, a video recording, audio recording, a professional document, a letter, an email, a record, a register, a newspaper, an update, a blog, a report, a log, a chronicle, a file, an advertisement, an internet webpage, a forum post, instant messaging, an archive or a catalogue or any other document which may be adapted to be read or assessed by the system.

In one embodiment, Natural Language Processing (NLP), machine learning or other analytical and/or statistical approaches may be incorporated into the compliance system and method to suggest real-time modifications or amendments, such that non-compliant text can be rectified before a full document compliance report can be issued. The system may further be adapted to categorize, declassify and/or consolidate text (published or otherwise) and may provide the basis for checking new rules or existing rule modifications to determine whether the rule provides adequate compliance. Suitable algorithms which may be used with the present invention may include: Logistic Regression, Naive Bayes, Nearest Neighbor, Inductive Logic Programming, Clustering and Representation Learning. It will be appreciated that other learning algorithms may be used with the present invention.

The compliance system and method may be adapted to be integrated or used as a plug-in or extension for web browser or document generation software, such as Google Chrome™, Apple Safari™, Firefox™, Microsoft Edge™, Microsoft Office™, OpenOffice™ Google Drive™, Adobe™ software, Facebook™, Instagram™, or the like. If the compliance system and method is adapted to be used as a plug-in, extension or is integrated into web browsers or document generation software, the system may monitor the time in which a user spends working in a document, the number of times the document is saved, and the number of documents generated, and log the document data. Based on the logged data, the system may determine whether a user is generating enough compliance reports to ensure training compliance, and if the system determines that the number of compliance reports is not sufficient, the user can be flagged for additional training.

Method for Assessing Keyword Risk Levels

The compliance system and method comprises assessing keyword risk levels and examples for each risk level tier. The following factors determine the keyword risk level.
1) Is the keyword a disease?
2) Is the keyword a disease state?
3) Does the keyword have an International Classification of Diseases (ICD) code?
4) Is the keyword a syndrome such as irritable bowel syndrome (IBS)?
5) Is the keyword a structure-function claim? Examples of structure-function claims are “calcium builds strong bones” and “antioxidants maintain cell integrity.”
6) Has the keyword been cited in warning letters?
7) Has the keyword been cited in warning letters within the past two years?
8) Has the keyword been cited in agency policy statements or press releases? Here is an example of an FDA News Announcement about the word “hangover.” Previously, the keyword “hangover” was not considered risky, but after this announcement and warning letters, “hangover” was elevated from a Low/Medium risk level to a Medium/High designation.
9) Has the keyword been discussed within the past 12 months in the trade press or by agency officials?

Example of each risk level tier.

Low: There is low to no risk of agency action.

Keyword examples: wellness, good health

Low/Medium: There is some risk associated, but there is a limited chance these keywords will lead to agency action. Some low/medium keywords are cited in warning letters but only where higher risk keywords are also cited.

Keyword examples: joint wellness, brain health, relief, soothe, stress

Medium: These keywords are commonly mentioned in agency action, but they are widely cited in warning letters when there are numerous occurrences of medium-risk words or when higher-risk words are also cited.

Keyword examples: joint pain, inflammation, gastritis

Medium/High: Good chance of agency action. One occurrence may not lead to agency action, but several occurrences significantly increase the risk.

Keyword examples: arthritis, heart disease, flu, fibromyalgia, insomnia, hangover

High: Strong chance of a warning letter. One occurrence may lead to a warning letter, and these words should always be avoided.

Keyword examples: cancer, Covid, Alzheimer's, Parkinson's.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. However, those of skill in the art should, in light of the present disclosure, appreciate that many changes can be made in the specific embodiments which are disclosed and still obtain a like or similar result without departing from the spirit and scope of the invention.

### Example 1: Warning Letter could have been Avoided if the Invention had been Utilized for Entia Biosciences, Inc

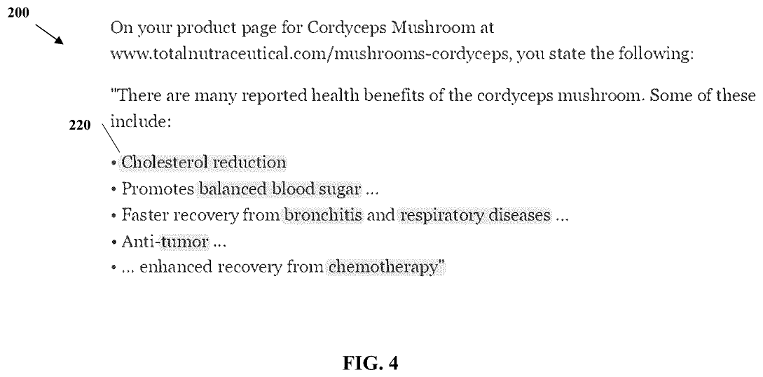

As shown in FIG. 4, Entia Biosciences received a warning letter 200 MARCS-CMS 610493, https://www.fda.gov/inspections-compliance-enforcement-and-criminal-investigations/warning-letters/entia-biosciences-inc-610493-01062021. The warning letter 200 cites claims made on the company's internet address http://www.totalnutraceutical.com. This includes risky claims 220 on the website product pages where the company discusses product and ingredient benefits.

The compliance system would search the keywords: lower cholesterol, anti-inflammatory, inflammation, reducing cholesterol, hypertension, prevent illness, liver disease, blood sugar, cancer, viral, infection, heart disease, high blood pressure, cholesterol reduction, high cholesterol, bronchitis, respiratory disease, tumor, chemotherapy.

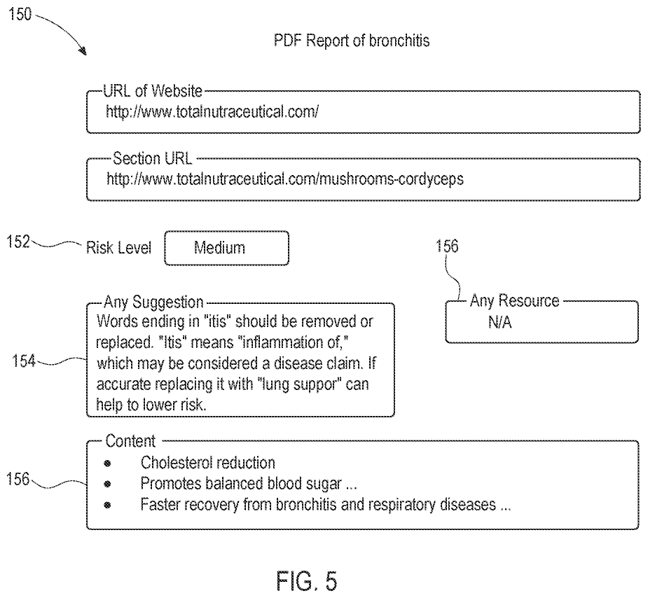

Entia would not have received the FDA warning letter. As shown in FIG. 5, the compliance system and method would have found the risky word “bronchitis”, provided the risk level at medium 150, and suggested alternative verbiage 152, thus dramatically mitigating the warning letter risk. A comparable report is provided for each keyword.

### Example 2: Warning Letter could have been Avoided if the Invention had been Utilized for FDC Nutrition Inc

FDC Nutrition Inc. received a FDA warning letter MARCS-CMS 612264 https://www.fda.gov/inspections-compliance-enforcement-and-criminal-investigations/warning-letters/fdc-nutrition-inc-612264-02182021.

The warning letter cites claims made on the company's internet address www.fdcnutrition.com. This involves risky claims on an image of the product label where the company discusses product benefits. Below is an example from the FDA warning letter.

### Example: FDA Warning Letter

On an image of the product label on your website:
“Reduce Anxiety by Affecting Serotonin”
“Aid Blood Sugar Control by Improving Insulin Sensitivity, Improve Fertility in Women With PCOS, Reduce Symptoms of Depression.”

The compliance system and method would have found the following keywords: anxiety, blood sugar control, Polycystic ovary syndrome (PCOS), depression.

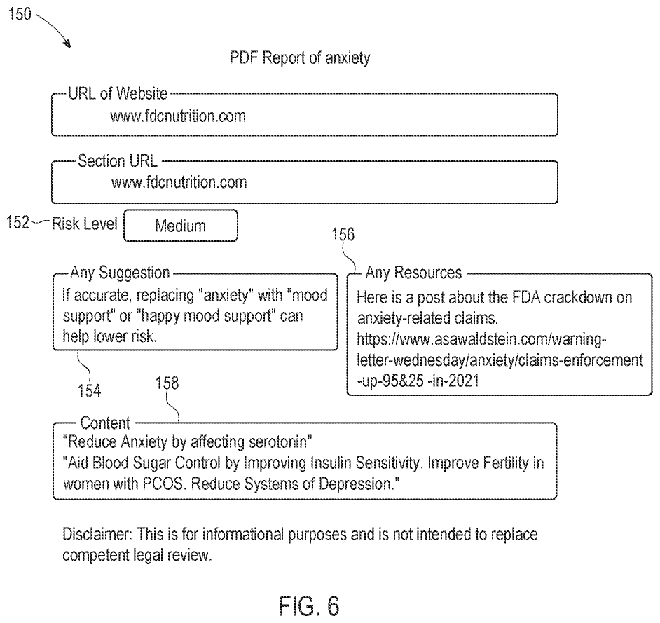

As shown in FIG. 6, the compliance system and method would have found the risky word “anxiety” and suggested alternative verbiage, thus dramatically mitigating the warning letter risk. A comparable report is provided for each keyword.

### Example 3: Warning Letter could have been Avoided if the Invention had been Utilized for Holographic Health, Inc

Holographic Health, Inc. received a FDA warning letter MARCS-CMS 613874 https://www.fda.gov/inspections-compliance-enforcement-and-criminal-investigations/warning-letters/holographic-health-inc-613874-09102021. The warning letter cites claims made on the company's internet address www.holographichealth.com. This includes risky claims made in testimonials. Below is an example from the FDA warning letter.

ASPARA-CAN
“Mrs. M. C., nurse, had been diagnosed with a large breast tumor by her medical doctor. I gave her Aspara-Can capsules to help with her imbalanced heart beat [sic]. After two months, the heart normalized, and the breast tumor (which I do not treat) reduced by over 60%!”

The compliance system and method would have found the following keywords: regulate blood sugar, regulates blood sugar, blood sugar regulation, balance blood sugar, inflammatory, inflammation, Celiac, heart rhythm regulation, hypertension, heart attack, stroke, paralysis, tumor, arrhythmia, arthritis, gout, pain, sore throat, cough, antitussive, antibacterial, nausea, chemotherapy, hernia, Gastroesophageal Reflux Disease, Crohn's, colitis, diarrhea, diverticulitis, Irritable Bowel Syndrome, IBS, colic, obesity, excessive urination, headache, diabetic, mental illness, numbness and tingling, erectile dysfunction, impotence, cardiovascular diseases, sexual dysfunction, cholera, diabetes, infertility, toothaches, lowers blood sugar, parasites, reduces fever, lowers cholesterol, depression, anxieties, phobia, depressive, schizophrenia, anxiety, infection, autoimmune, hemorrhoid, constipation, sore.

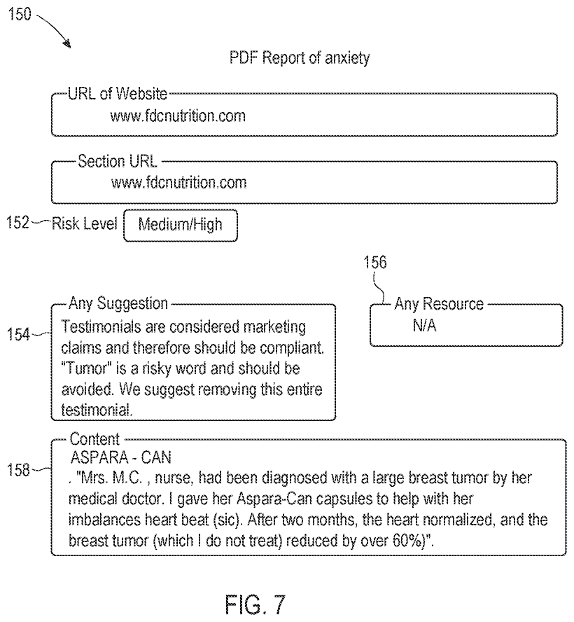

As shown in FIG. 7, the compliance system and method would have found the risky word “tumor” and suggested removing the testimonials, thus dramatically mitigating the warning letter risk. A comparable report is provided for each keyword.

### Example 4: Warning Letter could have been Avoided if the Invention had been Utilized for Holistic Healer & Wellness Center, Inc

Holistic Healer & Wellness Center, Inc. received a FDA warning letter MARCS-CMS 614538 https://www.fda.gov/inspections-compliance-enforcement-and-criminal-investigations/waming-letters/holistic-healer-wellness-center-inc-614538-09072021. The warning letter cites claims made on the company's website https://holistichealeronline.com/. This includes risky claims made about the ingredients and the suggested use. Below is an example from the FDA and FTC joint warning letter and FTC Cease and Desist Demand.
“The key ingredients are a helpful aid to people who have diabetes and hypoglycemia.”
“Blood sugar rises . . . It may lower elevated blood pressure . . . ”
“The Bitter Melon, Dandelion, Bilberry and Ginkgo biloba in this vegetarian capsule helps balance blood sugar levels for people with diabetes,”
“The combination of these ingredients helps with blood sugar control . . . ”
“Works great to lower high blood sugar . . . ”
“We recommend people with type 2 diabetes or those who are experiencing insulin resistance to opt for this holistic diabetes treatment.”

The compliance system and method would have found the following keywords: diabetes, hypoglycemia, elevated blood pressure, blood sugar control, high blood sugar

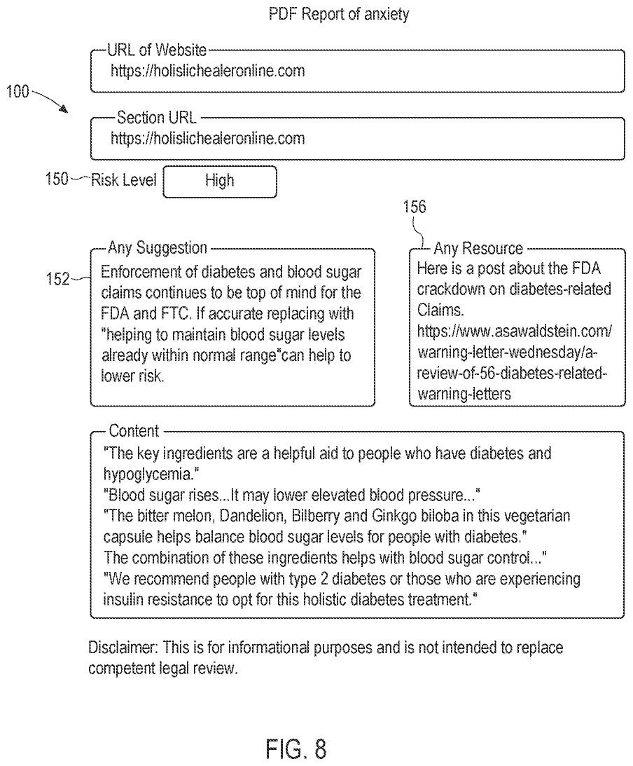

As shown in FIG. 8, the compliance system and method would have found the risky word “diabetes” and suggested alternative verbiage, thus dramatically mitigating the FTC cease and desist and joint FDA and FTC warning letter risk. A comparable report is provided for each keyword.

### Example 5: Warning Letter could have been Avoided if the Invention had been Utilized for Nuturna International LLC

Nuturna International LLC received a warning letter MARCS-CMS 614577 https://www.fda.gov/inspections-compliance-enforcement-and-criminal-investigations/warning-letters/nuturna-international-llc-614577-09072021. The warning letter cites claims made on the company's website https://nuturna.com and Amazon page. https://www.amazon.com/stores/Nuturna/Nuturna/page/69106B37-E335-4446-8FC4-A15C7CE0B73A. This includes risky claims made on Amazon about the product's benefits.

Below is an example from the FDA and FTC joint warning letter and FTC Cease and Desist Demand

### Example: FDA and FTC Joint Warning Letter

On your Amazon.com product page for “Diabetic Support Formula”;
“Support for Lower Blood Sugar Levels”
“Created by Diabetics for Diabetics . . . ”

The compliance system and method would have found the following keywords: diabetic, lower blood sugar, infection, diabetes, flu, lower my sugar levels

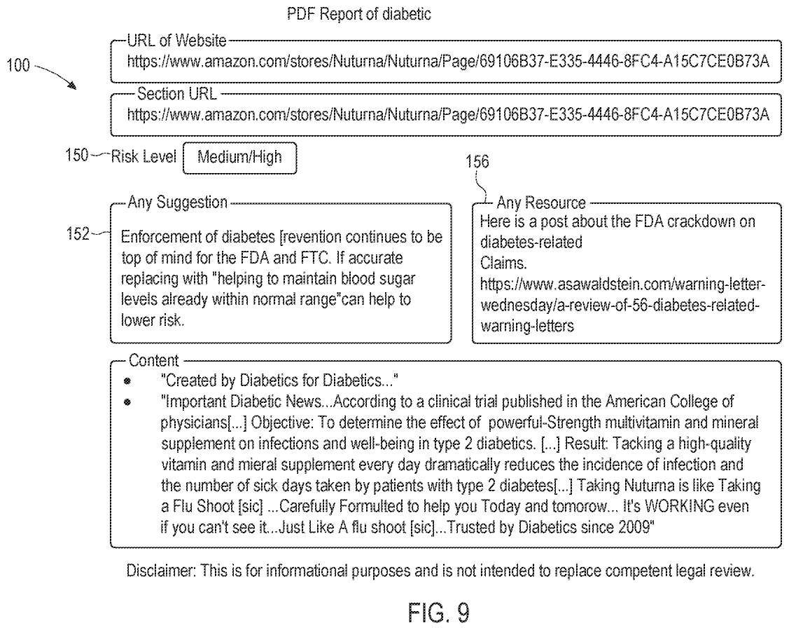

As shown in FIG. 9, the compliance system and method 100 would have found the risky word “diabetic” and suggested alternative verbiage, thus dramatically mitigating the FTC cease and desist and joint FDA and FTC warning letter risk. A comparable report is provided for each keyword.

### Example 6: Social Media

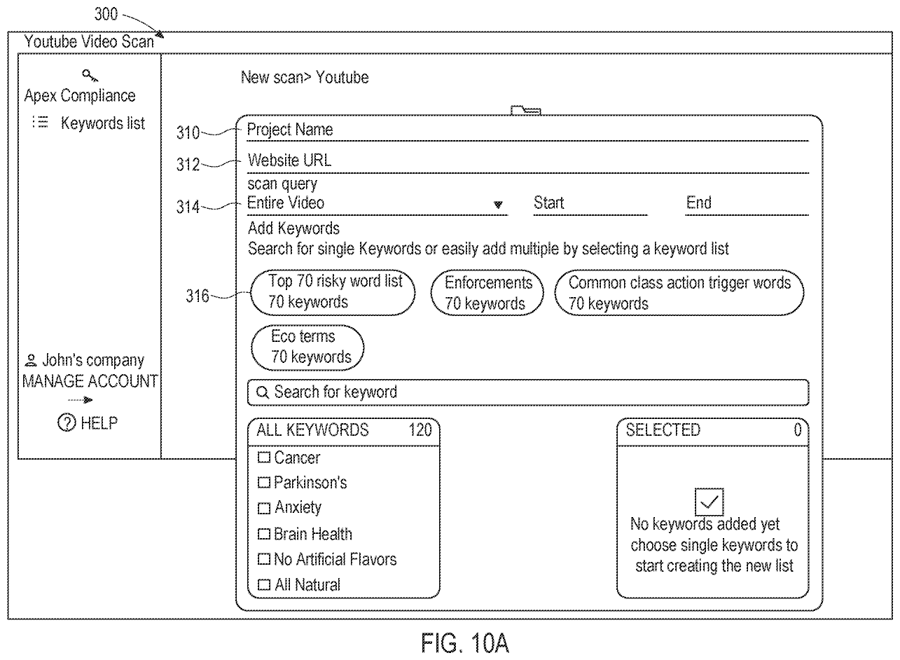

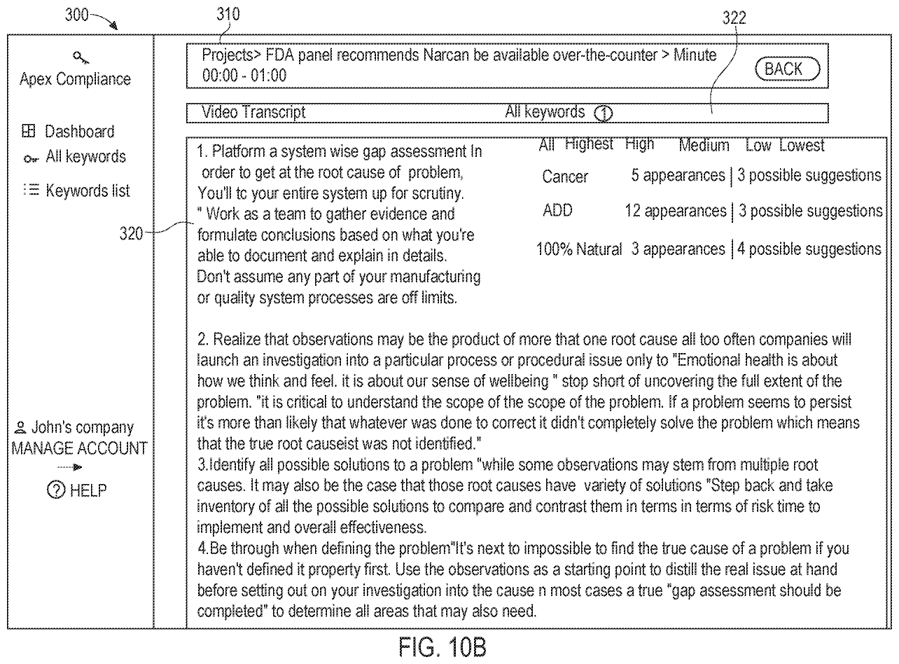

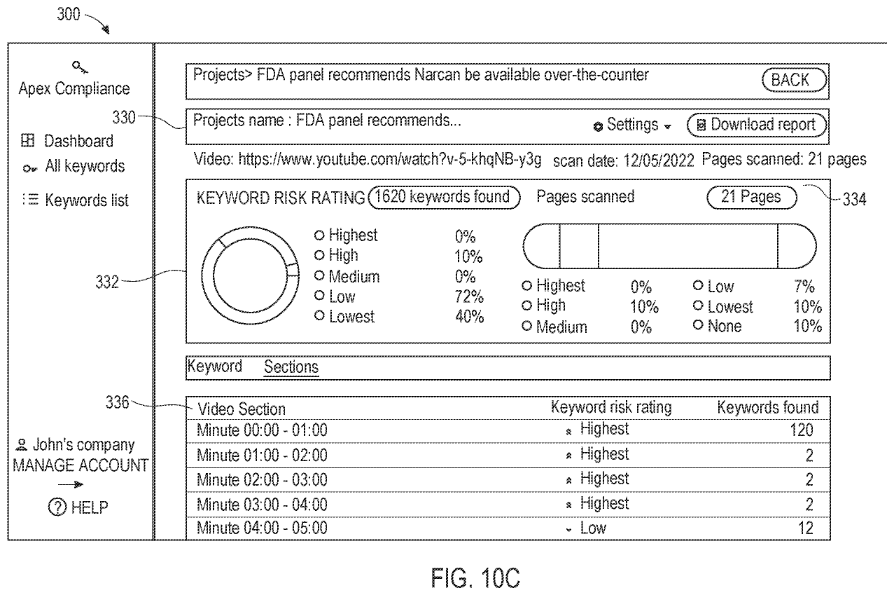

In one embodiment, the compliance system and method comprises assessing social media compliance by scanning social media platforms 300 such as YouTube, as shown in FIG. 10A. The compliance system and method for scanning social media platforms includes naming the project 310, entering the website URL 312, entering the video scan query 314, and adding keywords 316 to be scanned. All keywords may be selected or keywords may be added from a preselected list. As shown in FIG. 10B, the compliance system and method 300 generates a video transcript 320 and highlights the keywords flagged 322, showing the number of appearances of the flagged keyword and the number appearances of the keyword along with possible suggestions to replace the flagged keyword. As shown in FIG. 10C, the compliance system and method 300 generates a report 330 showing the keyword risk rating 332, showing the pages scanned 334 where the keyword risk rating is the highest, high, medium, low, lowest, and none. A drop down menu 336 also shows in the report the keyword risk rating and the video section in which the keyword appears showing the minute and second of the keyword appearing.

### Example 7: Document Scan Review

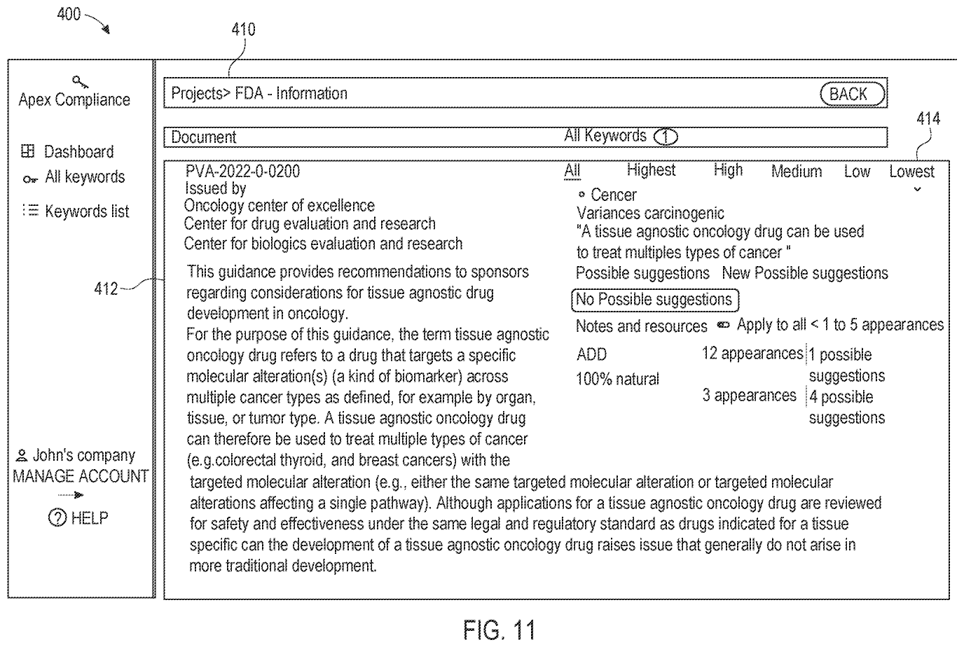

The compliance system and method comprises a document scan review 400, which finds risky phrases and suggest alternatives, as shown in FIG. 11. The compliance system and method comprises a find, educate, and replace function 412 in the document and lists the keywords 414 the highest, high, medium, low, and lowest risk keywords listed in the document scan.

### Example 8: Banking and Credit Card Reviews

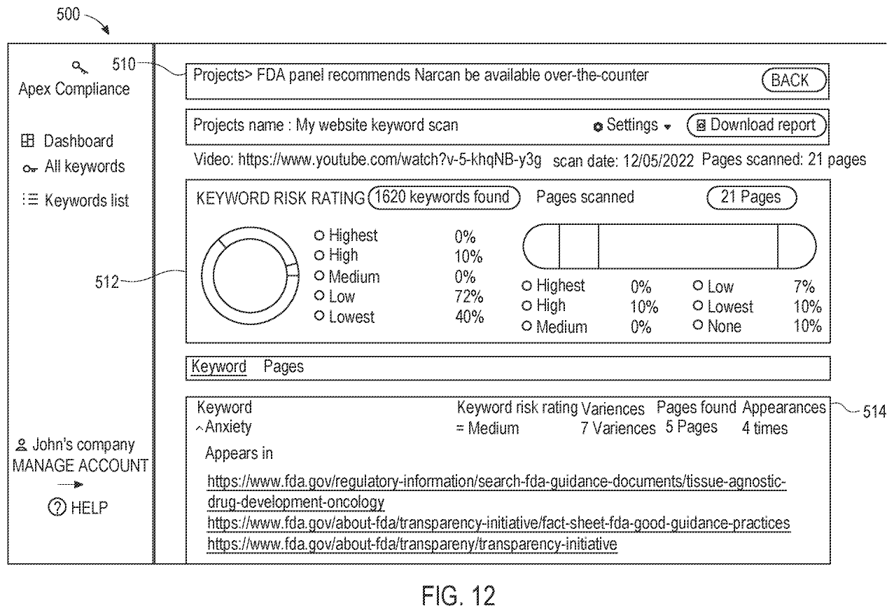

The compliance system and method by scanning for risky phrases in banking and credit card reviews 500, then identifying and suggesting alternatives that can help lower risk, as shown in FIG. 12. The compliance system and method by scanning for risky phrases in banking and credit card reviews 500 includes a project name 510, a dashboard report 512, and a keyword list 514. The dashboard report 510 provides a risk rating of highest, high, medium, low, and lowest, so a user can quickly identify if high-risk words are present. The keyword list 514 shows the number of variances of keyword risk appearances and the pages found.

### Example 9: Keyword Lists

The compliance system and method include a plurality of keyword lists for scanning different industries, businesses, videos, and documents. Customers can easily add keywords and make keyword lists such that multiple keyword lists can be used in the compliance system and method. An example of the keyword lists, risk rating, and suggested replacement words or phrases is listed in Table 1.

TABLE 1
Keyword List Name and Risk Rating

| | 50 | | |
|---|---|---|---|
| Keyword | risky words | | |
| list name* | Keyword | | Possible |
| Keyword* | Risk Rating* | Variances | Suggestion* |
| A | Highest | A | X |
| B | High | B | X |
| C | Medium | | X |
| D | Low | D | X |
| E | Lowest | E | X |
| ADD | Medium/High | | |
| ADHD | Medium/High | | |
| ALZ | High | | |
| Alzheimer | High | | |
| Anorexia | Medium/High | | |
| Anti- | Medium/High | antibacterial, | |
| bacterial | | antibacteria, | |
| | | prevents bacteria, | |
| | | prevents bacterial | |
| Anti- | Medium/High | antidepressant, | |
| depressant | | antidepressive | |
| Anti-fungal | Medium/High | antifungal, | |
| | | prevents fungal | |
| Anti- | Medium/High | antihypertensive, | heart support, |
| hypertensive | | hypertensive | cardiovascular |
| | | | support |
| Anti- | Medium | antiinflammatory, | body support, |
| inflammatory | | prevents | soothing |
| | | inflammation, | properties, |
| | | reduces | muscle |
| | | inflammation | resilience, |
| | | | supports optimal |
| | | | discomfort levels |
| Anti- | Medium/High | antimicrobial | |
| microbial | | | |
| Anti-viral | Medium/High | antiviral | |
| Anxiety | Medium/High | anxiolytic | mood support, |
| | | | happy mood |
| | | | support, |
| | | | supports |
| | | | happiness |
| Arthritis | Medium/High | arthritic | discomfort, |
| | | | joint support, |
| | | | supports |
| | | | healthy |
| | | | discomfort |
| | | | levels, relief, |
| | | | mobility support |
| Autism | High | autistic | |
| Bipolar | Medium/High | mood disorder | mood support |
| BPH | Medium/High | benign prostate | prostate support |
| | | hypertrophy | |
| Bulimina | Medium/High | | |
| Bronchitis | Medium | bronchial | lung support |
| | | inflammation | |
| Cancer | High | carcinogen, | |
| | | cancerous | |
| Cardio- | Medium/High | | heart support, |
| vascular | | | cardiovascular |
| disease | | | support |
| CFS | Medium/High | chronic fatigue | body support |
| | | syndrome | |
| COVID | High | coronavirus, | |
| | | sars-cov, c-19 | |
| Dementia | Medium/High | | |
| Depression | High | | |
| Diabetes | High | diabetic | |
| Epilepsy | High | epileptic | |
| Fever | Medium/High | pyrexia, | immune support |
| | | antipyretic | |
| Fibromyalgia | High | | |
| Flu | Medium/High | | immune support, |
| | | | wellness support |
| Hangover | Medium/High | | |
| Heart attack | Medium/High | myocardial | |
| | | infarction | |
| Hepatitis | Medium/High | | liver support |
| HIV | High | | |
| Hypertension | | | heart support, |
| | | | cardiovascular |
| | | | support |
| Infection | Medium/High | | body support, |
| | | | wellness support, |
| | | | immune support |
| Influenza | Medium/High | | immune support, |
| | | | wellness support |
| Insomnia | Medium/High | sleep disorder | sleep support, |
| | | | slumber support |
| Lyme disease | Medium/High | | body support |
| Migraine | Medium/High | | head support |
| Opioid | Medium/High | | |
| withdrawal | | | |
| Panic attack | Medium/High | | mood support |
| Parkinson's | High | | |
| PTSD | Medium/High | post traumatic | |
| | | stress disorder | |
| Reduces tumor | High | | |
| Reduction of | Medium | lowers | body support, |
| inflammation | | inflammation, | soothing |
| | | reduces | properties, |
| | | inflammation, | muscle |
| | | reduces | resilience, |
| | | inflammation, | supports |
| | | relief from | optimal |
| | | inflammation, | discomfort |
| | | relieve | levels |
| | | inflammation, | |
| | | relieves | |
| | | inflammation | |
| Schizophrenia | High | | |
| Seizure | Medium/High | | |
| STD | Medium/High | | |
| Stroke | Medium/High | | |
| Virus | Medium/High | prevents virus, | |
| | | prevents virus | |
| Wuhan | High | | |

System

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Software includes applications and algorithms. Software may be implemented in a smart phone, tablet, or personal computer, in the cloud, on a wearable device, or other computing or processing device. Software may include logs, journals, tables, games, recordings, communications, SMS messages, Web sites, charts, interactive tools, social networks, VOIP (Voice Over Internet Protocol), e-mails, and videos.

In some embodiments, some or all of the functions or process(es) described herein and performed by a computer program that is formed from computer readable program code and that is embodied in a computer readable medium. The phrase “computer readable program code” includes any type of computer code, including source code, object code, executable code, firmware, software, etc. The phrase “computer readable medium” includes any type of medium capable of being accessed by a computer, such as read only memory (ROM), random access memory (RAM), a hard disk drive, a compact disc (CD), a digital video disc (DVD), or any other type of memory.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A compliance system and method, comprising the steps:
a. finding keywords online and in documents;
b. ranking keywords by a risk level, and
c. providing lower-risk alternative words and educational resource links.

2. The compliance system and method of claim 1, further comprising designating the risk level as a highest risk, a high risk, a medium risk, a low risk, or a lowest risk.

3. The compliance system and method of claim 2, wherein the keywords are considered a regulatory risk.

4. The compliance system and method of claim 2, wherein the keywords include copywrite keywords and marketing keywords and replace keywords before publishing articles, social media posts, or blogs.

5. This compliance system and method of claim 2, wherein the keywords assess risk for credit card processors or banking institutions.

6. This compliance system and method of claim 2, wherein the highest risk, the high risk, and the medium risk means the keyword attracts scrutiny for a regulatory agency, wherein the scrutiny includes a lawsuit or a warning letter, and changing the highest risk, the high risk, and medium risk as suggested; the highest risk level includes a legal action or a lawsuit.

7. The compliant system and method of claim 2, further comprising a program, a web application, or a web browser extension.

8. The compliant system and method of claim 2, further comprising a web search, entering in a website URL and selecting from a predetermined list of keywords; opening all keyword occurrences and with a compliance report reporting the keyword, risk level, possible suggestions, resources, and listing the content.

9. The compliant system and method of claim 2, further comprising a live training and content development module.

10. The compliant system and method of claim 2, wherein the document include a newspaper article, a social media post, a video recording, audio recording, a professional document, a letter, an email, a record, a register, a newspaper, an update, a blog, a report, a log, a chronicle, a file, an advertisement, an internet webpage, a forum post, instant messaging, an archive or a catalogue or any other document which may be adapted to be read or assessed by the system.

11. The compliant system and method of claim 6, wherein the suggested replacement word is selected from the words in Table 1.

12. The compliant system and method of claim 11, wherein the highest risk, the high risk, and the medium risk words include variance words selected from the words in Table 1.

13. The compliant system and method of claim 11, wherein the highest risk, the high risk, and the medium risk words are selected from the group consisting of: keywords: regulate blood sugar, regulates blood sugar, blood sugar regulation, balance blood sugar, inflammatory, inflammation, Celiac, heart rhythm regulation, hypertension, heart attack, stroke, paralysis, tumor, arrhythmia, arthritis, gout, pain, sore throat, cough, antitussive, antibacterial, nausea, chemotherapy, hernia, Gastroesophageal Reflux Disease, Crohn's, colitis, diarrhea, diverticulitis, Irritable Bowel Syndrome, IBS, colic, obesity, excessive urination, headache, diabetic, mental illness, numbness and tingling, erectile dysfunction, impotence, cardiovascular diseases, sexual dysfunction, cholera, diabetes, infertility, toothaches, lowers blood sugar, parasites, reduces fever, lowers cholesterol, depression, anxieties, phobia, depressive, schizophrenia, anxiety, infection, autoimmune, hemorrhoid, constipation, sore.

14. The compliant system and method of claim 11, wherein the risk level is determined by whether the keyword a disease, the keyword a disease state, the keyword have an International Classification of Diseases (ICD) code, the keyword a syndrome such as irritable bowel syndrome (IBS), the keyword a structure-function claim, the keyword been cited in warning letters, the keyword been cited in warning letters within the past two years, or the keyword been cited in agency policy statements or press releases.
